(19) United States
(12) Patent Application Publication
(10) Pub. No.: US 2018/0098912 A1
(43) Pub. Date: Apr. 12, 2018

(54) ERGONOMIC MASSAGE THERAPY APRON

(71) Applicant: Luz Stella Hernandez, Miami, FL (US)

(72) Inventor: Luz Stella Hernandez, Miami, FL (US)

(21) Appl. No.: 15/290,529

(22) Filed: Oct. 11, 2016

(51) Int. Cl. A61H 37/00; A45F 3/00

(52) U.S. Cl. CPC A61H 37/00; A45F 3/005

(57) ABSTRACT

An ergonomic massage therapy apron that overcomes the discomfort caused to clients when using present massage therapy holsters and also prevents her uniform from being stained. The massage therapy apron comprises of an apron, the apron has a left, a right, a top, a bottom, a front and a back side. The left side of the apron is a strap that has a first hook and loop attachment means on the front of the apron that is adjacent to the end of the left side. The right side of the apron defines an apron body that runs from the right side of the apron toward the left side of the apron, the apron body has a height of at least 8 inches at the left side of the apron body and tapers as it goes toward the right side of the apron body. A first holsters is defined on the front side of the apron body and is adjacent to left side of the apron body. The right side of the apron has a hook and loop attachment means that is on the back of the apron that is adjacent to the right side of the apron. The apron is used to promote comfort to the patient being massaged and to prevent the dirtying of the therapist's uniform.

### BACKGROUND

The present invention is directed to an ergonomic massage therapy apron that is used to hold a bottle of massage oil on the hip of a user.

Presently, there are massage oil holsters that are placed on belts that hold the massage oil bottles on the belts of the users. The holsters are inconvenient to use, for when a massage is performed, the bottles that are placed on the holsters slide on the belt toward the front of the therapist, thereby placing the massage oil bottle in a position that may press against the patient when performing a massage. The pressure of massage oil bottle causes discomfort to the patient receiving the massage and also causes the therapist to manually move the holster with his or her massage oil drenched hands. When the massage oil drenched hands of the therapist move the holster, the uniform of the therapist is stained with the massage oil.

The problems described above made her realize that she had to design an apron that would not cause discomfort to the patient and that would prevent her uniform from being stained.

For the foregoing reasons she designed an ergonomic massage therapy apron that overcomes the discomfort caused to patients when using the present holsters in the massage therapy industry and that would also prevent her uniform from being stained.

### SUMMARY

The present invention describes an ergonomic massage therapy apron that overcomes the discomfort caused to patients when using present massage oil holsters and that also prevents massage therapists' uniforms from being stained.

The present invention comprises of an apron, the apron has a left, a right, a top, a bottom, a front and a back side. The left side of the apron is a strap that has a first hook and loop attachment means on the front of the apron that is adjacent to the end of the left side. The right side of the apron defines an apron body that runs from the right side of the apron toward the left side of the apron, the apron body has a height of at least 8 inches at the left side of the apron body and tapers as it goes toward the right side of the apron body. A first holsters is defined on the front side of the apron body and is adjacent to left side of the apron body. The right side of the apron has a hook and loop attachment means that is on the back of the apron that is adjacent to the right side of the apron.

In another embodiment of the present invention, a second holster is defined on the top of the apron body that is to the right of the first holster. The second holster is designed to hold an aromatherapy bottle. The importance of the placement of the bottle on the holster is that it allows the therapist to perform aromatherapy without losing contact with the patient.

Other embodiments of the present invention shall be described below: for example, an apron having a pocket in the back of the apron; and an apron having a third holster that will be used to hold a pen or similar device defined in the front of the apron.

An object of the present invention is to provide a massage therapy apron that will allow a massage therapy bottle to be fixedly draped on the hip of a massage therapist.

Another object of the present invention is to provide a massage therapy apron that will not place unwanted pressure on a patient receiving a massage.

A further object of the present invention is to provide a massage therapy apron that will prevent a massage therapist's clothes from being dirtied.

Still another object of the present invention is to provide a massage therapy apron that will enable a therapist not to lose contact with his or her client when providing aromatherapy treatment.

### DRAWINGS

These and other features, aspects, and advantages of the present invention will become better understood with regard to the following description, appended claims, and drawings where:

FIG. 1 is a front view of an ergonomic massage therapy apron; and

FIG. 2 is a back view of the ergonomic massage therapy apron.

### DESCRIPTION

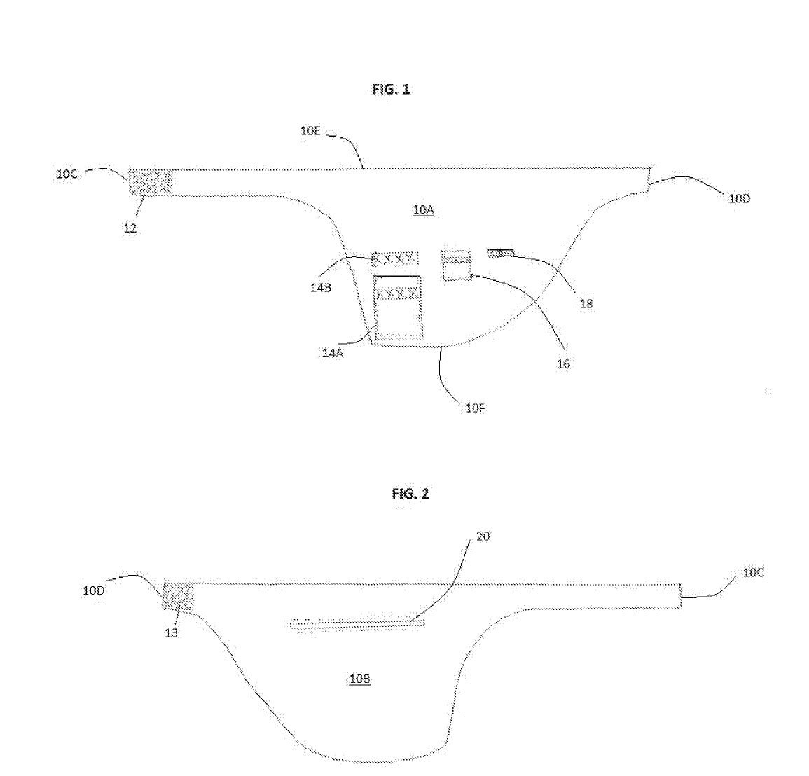

As seen in FIGS. 1-2, the present invention is an ergonomic massage therapy apron 100 that is worn on the hips of a therapist. The ergonomic massage therapy apron 100 comprises of an apron 100, the apron has a left 10C, a right 10D, a top 10E, a bottom 10F, a front 10A and a back side 10B. The left side 10C of the apron is a strap that has a first hook and loop attachment means 12 on the front of the apron 10A that is adjacent to the end of the left side 10C. The right side of the apron 10D defines an apron body 10A-10B that runs from the right side of the apron 10D toward the left side of the apron 10C, the apron body 10A-10D has a height of at least 8 inches at the left side of the apron 10C and tapers as it goes toward the right side of the apron 10D. A first holsters 14A-14B is defined on the front side of the apron body 10A and is adjacent to left side of the apron 10C. The right side of the apron 10D has a hook and loop attachment means 13 that is on the back of the apron 10B that is adjacent to the right side of the apron 10D.

In another embodiment of the present invention, a second holster 16 is defined on the top of the apron body 10A that is to the right of the first holster 14A-14B. The second holster 16 is designed to hold an aromatherapy bottle. The importance of the placement of the aromatherapy bottle on the second holster 16 is that it allows the therapist to perform aromatherapy without losing contact with the patient.

In a further embodiment of the present invention, a third holster 18 is defined on the top of the apron body 10A that is to the right of the second holster 16. The third holder 18 may be used to hold a pen or a similar device.

In still another embodiment of the present invention, a pocket 20 is defined on the back side of the apron body 10B.

In yet still another embodiment of the present invention, the apron body is made of a vinyl material.

It is foreseen that the left and right sides of the invention can be changed so that the present invention can be used by a right or left handed therapist, the only difference would be that the description described above would be written in a mirror manner.

An advantage of the present invention is that it provides a massage therapy apron that allows a massage therapy bottle to be fixedly draped on the hip of a massage therapist.

Another advantage of the present invention is that it provides a massage therapy apron that will not place unwanted pressure on a patient receiving a massage.

A further advantage of the present invention is that it provides a massage therapy apron that prevents a massage therapist's clothes from being dirtied.

Still another advantage of the present invention is that it provides a massage therapy apron that enables a therapist to not lose contact with his or her client when providing aromatherapy treatment.

While the inventor's above description contains many specificities, these should not be construed as limitations on the scope, but rather as an exemplification of several preferred embodiments thereof. Many other variations are possible. For example, the present invention can be described to switch the placement of the apron body, the holsters and the pocket so that the apron could be worn either on the left or the right side of the therapist. Accordingly, the scope should be determined not by the embodiments illustrated, but by the appended claims and their legal equivalents.

What is claimed is:

1. An ergonomic massage therapy apron that is worn on the hips of a therapist, the ergonomic massage therapy apron comprises of:
an apron that has a left, a right, a top, a bottom, a front and a back side, the left side of the apron is a strap that has a first hook and loop attachment means on the front of the apron that is adjacent to the end of the left side, the right side of the apron defines an apron body that runs from the right side of the apron toward the left side of the apron, the apron body has a height of at least inches at the left side of the apron body and tapers as it goes toward the right side of the apron;
a first holsters is defined on the front side of the apron body and is adjacent to left side of the apron body; and
a hook and loop attachment means that is on the back of the apron that is adjacent to the right side of the apron.

2. The ergonomic massage therapy apron that is worn on the hips of a therapist of claim 1, further comprising of a second holster that is defined on the top of the apron body that is to the right of the first holster.

3. The ergonomic massage therapy apron that is worn on the hips of a therapist of claim 2, further comprising a third holster that is defined on the top of the apron body that is to the right of the second holster.

4. The ergonomic massage therapy apron that is worn on the hips of a therapist of claim 3, further comprising a pocket that is defined on the back side of the apron body.

5. The ergonomic massage therapy apron that is worn on the hips of a therapist of claim 1, wherein the apron body is made of a vinyl material.
